(19) United States
(12) Patent Application Publication
(10) Pub. No.: US 2026/0209393 A1
(43) Pub. Date: Jul. 23, 2026

(54) METHODS OF GENERATING THERMORESPONSIVE POLY SACCHARIDES AND USES THEREOF

(71) Applicant: University of New Hampshire, Durham, NH (US)

(72) Inventors: Linqing LI, Dover, NH (US); Saniya Yesmin BUBLI, Concord, NH (US)

(21) Appl. No.: 19/506,346

(22) PCT Filed: Jul. 26, 2024
(86) PCT No.: PCT/US2024/039851

§ 371 Date: Jan. 28, 2026

Related U.S. Application Data
(60) Provisional application No. 63/516,311, filed on Jul. 28, 2023.

(51) Int. Cl. C08B 37/00; C08J 3/07; C08J 3/075; C08J 3/24

(52) U.S. Cl. CPC C08B 37/0006; C08J 3/07; C08J 3/075; C08J 3/24; C08J 2305/00

(57) ABSTRACT

Thermoresponsive polysaccharide-based materials with tunable transition temperatures regulating phase-separated microdomains are provided. The process attaches hydrophobic adducts to the backbone of hydrophilic dextran and gradually increases the hydrophobicity of the dextran chains to engineer phase separation. Conjugating methacrylate moieties to the dextran backbone yielded a continuous increase in macromolecular hydrophobicity that induced a reversible phase transition whose lower critical solution temperature can be modulated via variations in polysaccharide concentration, molecular weight, degree of methacrylation, ionic strength, surfactants, urea and Hofmeister salts. The phase separation is driven by increased hydrophobic interactions of methacrylate residues, where the addition of surfactants and urea can disassociate hydrophobic interactions and eliminates phase transition.

### STATEMENT REGARDING FEDERALLY SPONSORED RESEARCH

This invention was made with government support under Sponsor ID 961152880, Grant #1757371, awarded by the National Science Foundation. The government has certain rights in the invention.

### FIELD OF THE DISCLOSURE

The present disclosure relates generally to thermoresponsive materials and, specifically, to thermoresponsive polysaccharides.

### BACKGROUND

Smart materials that can alter their properties in response to temperature changes are called thermoresponsive materials. Thermoresponsive materials derived from natural or synthetic macromolecules that undergo reversible phase transitions hold much promise for a variety of biomedical applications including drug delivery, biosensors, separation and purification process. Strategies to develop thermoresponsive polysaccharide-based materials with precisely controlled lower critical solution temperature (LCST) and phase transition can offer improved bioactivity and biocompatibility.

Thermoresponsive polysaccharide systems have relied on conjugating temperature sensitive polymers to the polysaccharides, where the selection of synthetic polymer and the degree of conjugation regulate the thermal behavior of these block-co-polymers. Although multiple parameters can tune the phase transition, it remains challenging to systematically and precisely control the transition temperatures and thermal properties of these polysaccharide-polymer block-copolymers, as the thermal behavior of these block-co-polymers depends on the selection of synthetic polymer and the degree of conjugation.

### SUMMARY

In one aspect a reversible phase transition material is provided. The material can change phases at different temperatures. For instance, it can be a transparent or translucent solution at a low temperature and contain solid domains at a high temperature. The material can be based on a homopolymer polysaccharide. The polysaccharide can be comprised of repeating glucose units. The homopolymer can be rendered a phase transition material by increasing the hydrophobicity of the homopolymer. This can be done without grafting other polymers and without polymerizing reactions. Various percentages of the repeating OH units on the polysaccharide can be reacted, such as by acylation or methacrylation, to render the backbone of the polysaccharide more hydrophobic (less hydrophilic). The system can be tuned to specific lower critical solution temperature (LCST) by varying, for example, the molecular weight of the material, the amount of branching in the material, the hydrophobicity of the material, the compound or compounds being reacted with the hydroxyl groups, the amount of hydroxyl groups being reacted, the presence of additives in the system, the concentration of the material in the aqueous solvent, the presence of cosolvents, the ionic strength of the aqueous solvent. The reversible phase transition material can change phases multiple times in response to temperature change without the addition or subtraction of material. The phase transition does not affect the chemical structure of the modified polysaccharide.

The initial polysaccharide can be a branched polysaccharide and can be of any molecular weight. It can be a homopolymer such as a glucose homopolymer. The modified polysaccharide can be safe for in vivo use. Examples include glucans such as dextran.

The polysaccharide can be reacted with one or more compounds that react with the hydroxyl group of the individual saccharide molecules to render the polysaccharide more hydrophobic. These compounds include, for example, acrylates, methacrylates, anhydrides. Specific examples include glycidyl acrylate, methacrylic anhydride and methacrylate.

The LCST can be varied so that the phase transition can happen at greater than or less than 10° C., 20° C., 30° C., 40° C., 50° C., 60° C., 70° C., 80° C., 90° C. and 100° C.

The solvent can be an aqueous solvent and can be cytocompatible. For example, the solvent can be phosphate buffered saline (PBS). The aqueous system can include salts such as Hofmeister salts and can include urea or other compounds exhibiting amino groups. The solvent can also include surfactants such as sodium dodecyl sulfate (SDS).

Hydrogels can be produced from the modified polysaccharides. For instance, hydrogels can be made via UV catalyzed crosslinking. Fast cross-linking reactions can be implemented at different points during the relatively slower phase change. This allows for options to form hydrogels from modified polysaccharides at various levels of phase transition. The modified polysaccharide hydrogels can be used as scaffolding for cell growth. In other embodiments, the hydrogels can hold drugs, and the rate of drug delivery can be selected by selecting a specific modified polysaccharide and/or the conditions of making the hydrogel.

### BRIEF DESCRIPTION OF THE DRAWINGS

FIG. 1 illustrates a chemical reaction for one embodiment;

FIG. 2a provides NMR data for four different methacrylated dextrans;

FIG. 2b provides FTIR an spectrograph illustrating the bonds present in four embodiments;

FIG. 3a is a theoretical drawing showing the reversible phase transition properties of one set of embodiments;

FIG. 3b illustrates the opacity of five different embodiments of Dex-MA at different temperatures;

FIG. 4 is a graph showing the DLS particle size of five different embodiments;

FIG. 5 is a graph showing particle size vs. intensity;

FIG. 6 is a graph illustrating particle size of different embodiments at different temperatures;

FIG. 7 is a graph illustrating the transition temperature of different molecular weight Dex-MA compounds;

FIG. 8 is a graph illustrating the reversibility of the phase change of one embodiment;

FIG. 9 is an SEM micrograph of phase separated domains of one embodiment;

FIG. 10 is an SEM micrograph of phase separated domains of a second embodiment;

FIG. 11 is an SEM micrograph of phase separated domains of a third embodiment;

FIG. 12 provides a scatter diagram of microdomain size distribution at various temperatures with statistical analysis;

FIG. 13 provides flow imaging microscopy images for one embodiment;

FIG. 14 provides flow imaging microscopy images for a second embodiment;

FIG. 15 provides flow imaging microscopy images for a third embodiment;

FIG. 16 provides a scatter diagram of particle size distribution for the embodiments of FIGS. 13-15;

FIG. 17 provides a schematic demonstration of the setup of in vitro cell culture in the presence of phase separated Dex-MA solution;

FIG. 18 is a phase contrast micrograph of cells and phase separated Dex-MA;

FIG. 19 is a fluorescent image of human dermal fibroblasts under different conditions;

FIG. 20 is a bar graph illustrating cell viability in DMEM media containing Dex-MA vs the control group;

FIG. 21 provides a confocal microscope image of HDF cells cultured in the presence of phase-separated Dex-MA solutions in DMEM media and DMEM media without Dex-MA;

FIG. 22 is a flow chart illustrating a method of making a hydrogel from Dex-MA;

FIG. 23 is a phase contrast microscope image of one embodiment of photo-crosslinked non phase separated Dex-MA;

FIG. 24 provides a phase contrast microscope image of an embodiment of photo-crosslinked phase separated Dex-MA;

FIG. 25 is a graph illustrating absorbance at different concentrations of SDS;

FIG. 26 is a graph illustrating absorbance at different concentrations of urea;

FIG. 27 is a graph illustrating the effect of SDS and urea on transition temperature;

FIG. 28 graphically provides the hydrodynamic radius profiles for Dex-MA in the presence of different anions;

FIG. 29 is a graph showing the effect on transition temperature of various anions;

FIG. 30 graphically provides the hydrodynamic radius profiles for Dex-MA in the presence of different cations;

FIG. 31 is a graph showing the effect on transition temperature of various cations;

FIG. 32 graphically provides the hydrodynamic radius profiles for Dex-MA in the presence of different concentrations of sodium chloride;

FIG. 33 graphically shows the effect on transition temperature of different concentrations of chloride and sulfate;

FIG. 34 shows six micrographs illustrating the autofluorescence of various drug loaded gels;

FIG. 35 graphically illustrates the rate of drug release of three different embodiments of Dex-MA;

FIGS. 36a and 36b provide schematic illustrations of cell proliferation on non-phase separated and phase separated Dex-MA hydrogels, respectively; and

FIGS. 37a, 37b and 37c are micrographs that show the encapsulation of human dermal fibroblasts in non-phase separated and phase separated hydrogels.

Various aspects of at least one example are discussed below with reference to the accompanying figure, which is not intended to be drawn to scale. The figure is included to provide an illustration and a further understanding of the various aspects and examples and are incorporated in and constitute a part of this specification, but are not intended to limit the scope of the disclosure. The drawings, together with the remainder of the specification, serve to explain principles and operations of the described and claimed aspects and examples. For purposes of clarity, not every component may be labeled in every figure.

### GENERAL OVERVIEW

Disclosed herein is a simplified and well controlled synthetic approach that can avoid the multiple steps of traditional chemical conjugation, or block-co-polymer synthesis, or purification steps, offering a new route to efficiently generate novel thermoresponsive polysaccharides-based materials with precisely controlled transition temperature and phase separation.

To convert non-thermoresponsive polysaccharides into thermoresponsive materials with tunable transition temperatures, the process described herein provides for chemical modification to introduce hydrophobic residues to the hydrophilic polymeric backbone of a polysaccharide such as dextran. This is in contrast to conjugating a thermosensitive block to/from dextran. The instant process provides an overall macromolecular hydrophobicity that triggers effective phase separation. Native dextran does not exhibit temperature-dependent phase separation due to ample hydroxyl groups on the polymer backbone, however, systematically attaching hydrophobic methacrylate groups to the dextran backbone through these hydroxyl residues can result in a continuous increase in macromolecular hydrophobicity. The result is synthetic dextran-derivatives with temperature-induced reversible phase transitions whose lower critical solution temperatures and associated phase separated microdomains sizes can be precisely tuned by material compositions and solution conditions.

The processes described herein provide one step chemical modification to convert hydrophilic polysaccharides to hydrophobic polysaccharides, resulting in a straightforward method to induce phase separation in polysaccharide-based materials in aqueous solutions. The disclosed processes eliminate the need for any specific instrument or organic solvents to induce phase separation, and, in some embodiments eliminate the need for any additional purification process.

A material system where phase transition can be systematically tuned and defined without multiple steps of chemical conjugation or purification has broad utility. The disclosed method to modify macromolecular hydrophobicity by introducing hydrophobic adducts to hydrophilic polysaccharide dextran backbones not only effectively induces reversible phase transition, but also precisely tunes the transition temperatures and phase-separated microdomain sizes by defined chemical modification. The precise control of methacrylation functionality permits the tuning of macromolecular hydrophobicity and independent manipulation of transition temperatures in a well-defined manner, making it advantageous compared to traditional co-polymer grafting approaches in many other systems. In addition, the phase separated material can form phase-separated microstructured hydrogels that avoids the need of any specific instrument (e.g., microfluidics, photolithography, or batch emulsion).

### DETAILED DESCRIPTION

Phase separation is a thermodynamically and kinetically driven process where a single homogeneous solution separates into two distinct phases via either lower critical solution temperature (LCST) or upper critical solution temperature (UCST), respective critical temperature points above and below which polymers undergo transition from solution to aggregates. This phase transition behavior of thermoresponsive macromolecules can be controlled by a variety of factors that include the degree of polymerization, polymer topologies, hydrophilic to hydrophobic ratios, and stimuli such as temperature, pH, concentration, molecular weight, ionic strength and specific salt types. As provided herein, temperature is one of the most easily applied factors to modulate the solution properties of materials.

Polysaccharides can combine the chemical versatility and material processing efficiency of synthetic polymers with improved bioactivity and biocompatibility from natural biopolymers. Accessing different molecular weights with a large number of available reactive moieties along the polysaccharide backbone permits systematic tuning and precise chemical modification to achieve desired material composition and structure/property relationships.

The methods described herein can convert non-thermoresponsive polysaccharides into thermoresponsive materials without the requirement of conjugating polymers to generate block-copolymers. A one step chemical modification introduces hydrophobic residues to the hydrophilic backbone of a polysaccharide such as dextran, a simple but controlled method, to increase the overall macromolecular hydrophobicity that triggers effective and precise phase separation. Dextran is used herein as an example of a compatible polysaccharide. Dextran is a non-toxic, biocompatible, biodegradable and FDA approved macromolecule and thus an attractive candidate for tissue engineering applications. By conjugating methacrylates to the hydroxyl groups of the dextran backbone, a gradual increase in hydrophobicity of modified dextran macromers results in induced phase transitions of previously hydrophilic, non-phase separating dextran macromolecules. This can result in a single-phase material at low temperatures and a phase separated material at higher temperatures. The lower critical solution temperature (LCST) and phase-separated microdomain sizes can be further tuned by varying material compositions and solution conditions, as characterized via dynamic light scattering (DLS) and UV-vis spectroscopy. The morphology and stability of the microdomains have been confirmed by scanning electron microscopy (SEM) and flow imaging microscopy (FlowCam).

Cultures of human dermal fibroblasts show well tolerated cytocompatibility of phase separated domains. The thermoresponsive Dex-MA macromers allow for UV-initiated crosslinking to form heterogeneous and microstructured hydrogels by capturing the microdomains upon phase separation. Unlike conventional polymer-grafting to polysaccharide copolymer, this bottom-up approach establishes a class of novel and finely-tuned thermoresponsive polysaccharides and offers a simplified strategy to capture phase separation and microdomains in hydrogels that can be used in mechanobiology and wound healing applications.

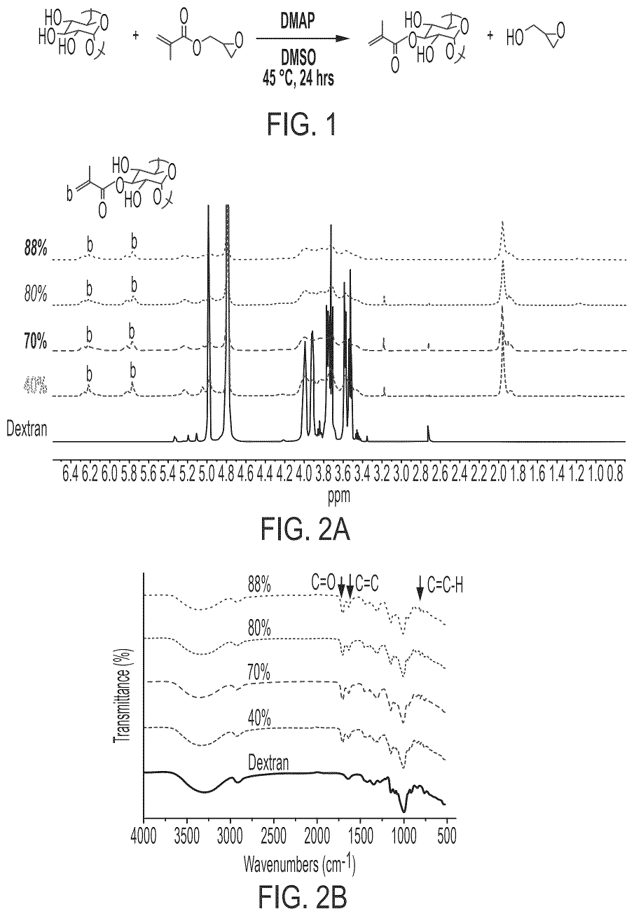

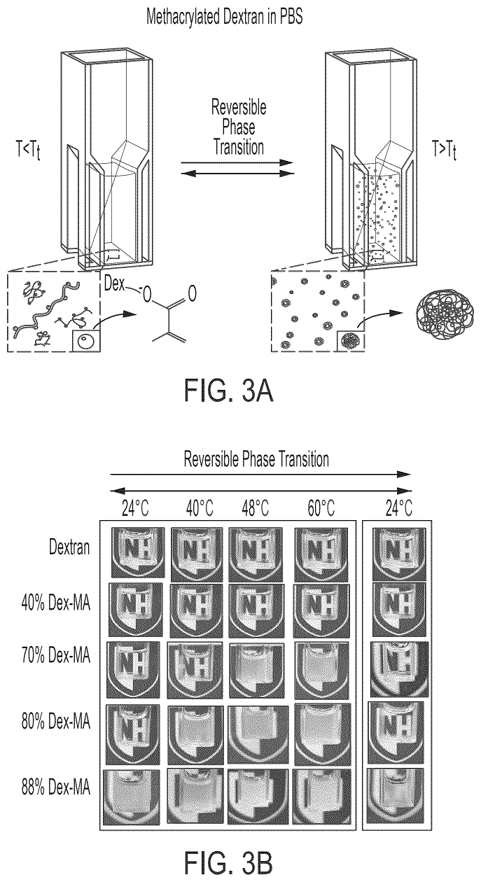

To engineer a phase transition in intrinsically hydrophilic polysaccharides, it has been found that gradually increasing the hydrophobicity of the polymer backbone will trigger a reversible phase separation that exhibits a lower critical solution temperature. Dextran, a neutral and hydrophilic homo-polysaccharide, was selected as the base material and chemically modified with glycidyl methacrylates (GMA) via reactive hydroxyl groups to yield methacrylated dextran (Dex-MA, FIG. 1). The degree of methacrylation can be tuned via changing the molar ratio of GMA to glucopyranose residues in order to achieve a wide range of functionality (40%~80%), confirmed by NMR and FTIR. See FIGS. 2a and 2b. To explore whether changing the overall hydrophobicity of modified dextran can induce a phase transition, solutions of Dex-MA at 10 mg/mL concentration with different methacrylation degrees (0%~88%) were heated and the phase transition behavior was monitored over time (FIG. 3b).

Methacrylated dextrans with different functionalities (f=40%, 70%, 80% and 88%; Mw~86 kDa) were compared to non-modified dextran. Lowering the solubility of Dex-MA by increasing the solution temperature resulted in a clear phase separation that generated two immiscible liquid phases, a dense Dex-MA phase, and a dilute equilibrium phase, therefore the cloudy appearance of the Dex-MA solutions denotes the phase transition. Non-modified dextran and 40% modified Dex-MA samples showed no phase separation across the range of temperatures tested, depicted by the clear visibility of the UNH logo (FIG. 3b). Increasing temperature of both the 70% and 80% modified Dex-MA solutions induced obvious phase separation followed by rapid clearance of cloudiness (~mins) upon returning to room temperature, indicative of a reversible phase transition. Interestingly, 88% modified Dex-MA solutions displayed a dense cloudy appearance and maintained phase separation at room temperature, showing that its lower critical solution temperature (LCST) is below room temperature. The correlation between the degree of methacrylation and associated phase transition suggests that increased methacrylate content on hydrophilic dextran backbone converts overall macromolecular hydrophobicity that triggers reversible phase transitions.

### Processes and Results

Dextran (from Leuconostoc mesenteroides, Mw: 40~500 kDa) was purchased from MP Biomedicals (Irvine, CA). Dimethyl sulfoxide (DMSO, anhydrous), glycidyl methacrylate (GMA), 4-(N, N-dimethylamino) pyridine (DMAP) and all other reagents were purchased from Sigma Aldrich (St. Louis, MO). Dialysis tubing semi-permeable membrane with a molecular weight cut off 10,000 Da was purchased from Thermo Fisher Scientific (Waltham, MA).

To synthesize methacrylated dextran with various degrees of functionalities, dextran (2.0 g, Mw: 40 kDa ~500 kDa) was dissolved in 10 mL of anhydrous dimethyl sulfoxide (DMSO) with the addition to 0.2 g of base catalyst 4-dimethylamino pyridine (DMAP) and the required molar equivalent of glycidyl methacrylate (GMA, density=1.042 g/ml at 25° C.). The mixture solution was kept at a constant 45° C. and stirred for 24 hours. After stirring, the reaction solution was pipetted dropwise into a 200 mL of ice-chilled isopropanol to precipitate modified dextran. The precipitation was then collected via centrifugation and subsequently re-dissolved and dialyzed against 4 L of milli-Q water at a temperature of 4° C. preceding lyophilization. Purified methacrylated-dextran (Dex-MA) was stored at −20° C. until use. The reaction pathway is provided in FIG. 1. The functionality and degree of methacrylation of Dex-MA were analyzed using nuclear magnetic resonance spectroscopy (NMR, a 700 MHz Bruker BioSpin spectrometer, in D₂O/DMSO), and results are shown in FIG. 2a. The degree of methacrylation was shown to be 40%~88% modification depending on the initial molar equivalent ratio of glycidyl methacrylate to glucopyranose. The peaks at 5.75 and 6.2 ppm represent the protons at the double bond of the glycidal methacrylate (GMA) group.

FIG. 2b provides FTIR spectroscopy results for the resulting Dex-MA. This analysis was performed using a Thermo Nicolet iS10. Spectra taken at a resolution of 4 cm⁻¹ from 400 to 4000 cm−1 were obtained by signal averaging 32 scans. Dried samples of non-modified dextran and Dex-MA were loaded and pressed to obtain contact with the diamond crystal plate for collecting the spectra. FTIR transmissions were recorded at 1706 cm⁻¹ for carbonyl groups, and double bonds of GMA were detected at 813 cm⁻¹ and 1640 cm⁻¹. Omnic software was used for data collection and analysis.

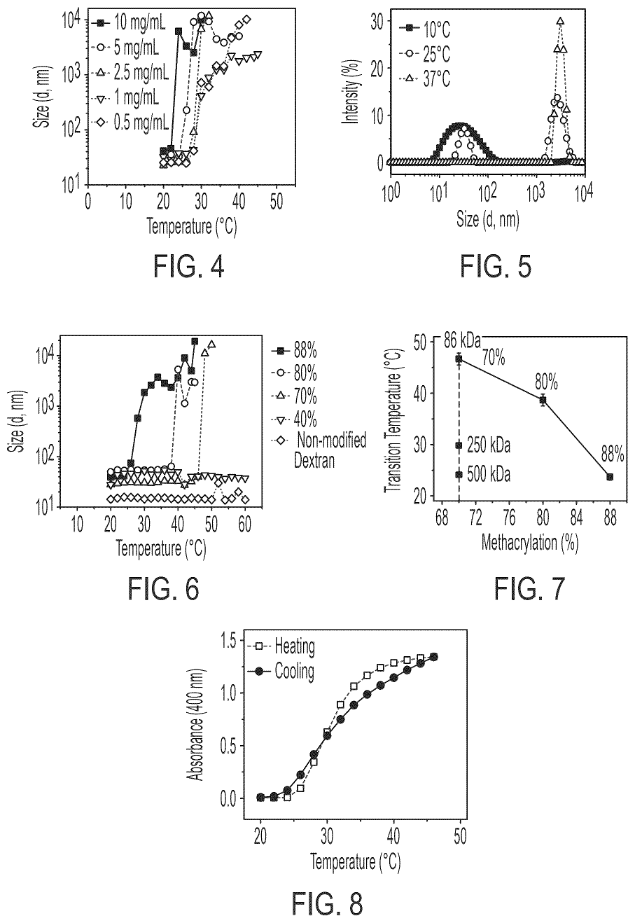

FIG. 4 provides the average size change of dextran-based particles as a function of temperature when analyzed via dynamic light scattering (DLS) using a Malvern Zetasizer Nano ZS instrument (Malvern Instruments Ltd, Worcestershire, UK). Dextran samples (1 mL) at various polysaccharide concentrations (0.1~10 mg/mL) were prepared in phosphate-buffered saline solution (PBS, pH~7) in disposable or glass cuvettes before measurement. The transition temperature was determined to be the temperature at which a sharp increase in particle size was observed. The accuracy of the transition temperature is approximately ±1° C. Results indicate that a variation in the amount of GMA can provide for a variation in transition temperature from 25 to 40° C. In other embodiments, the transition temperature can be, for example, from 15 to 20° C., from 20 to 25° C., from 25 to 30° C., from 30 to 35° C., from 35 to 40° C. or greater than or equal to 45° C. FIG. 5 provides intensity (%) of a Dex-MA in PBS (pH~7.4) solutions as a function of size at different temperatures (Mw: 86 kDa, f=88%). FIG. 6 illustrates tunable transition temperatures obtained by controlling the degree of methacrylation in PBS (pH~7.4) at 10 mg/mL solution concentration (Mw: 86 kDa). Results are provided for 40%, 70%, 80% and 88% methacrylation of the dextran. FIG. 7 provides graphical results for different molecular weight dextran samples (86 kDa, 250 kDa, 500 kDa) at different degrees of methacrylation.

Samples are in PBS (pH~7.4) at 10 mg/mL. Results show that the LCST of modified dextran is reduced at higher molecular weights. FIG. 8 provides UV-VIS (400 nm) results showing the reversible heating and cooling properties of Dex-MA in PBS (pH~7.4) at 1 mg/ml sample concentration (Mw: 86 kDa, f=88%).

The turbidity of dextran samples was obtained by measuring solution absorbance at 400 nm wavelength as a function of temperature. All samples were characterized in a glass cuvette for turbidity assay using a Cary 3500 UV-Vis spectrophotometer (Agilent Technologies, Santa Clara, CA) equipped with a temperature-controlled cell holder. The solution temperature was increased from 10° C. to 60° C. at a constant 1° or 2° C./min interval heating scanning rate until a plateau was achieved in absorbance value. A baseline absorbance curve of PBS solution was collected as a reference before each sample run. The transition temperature was determined considering the inflection point (rise in the absorbance spectrum) of the absorption curve.

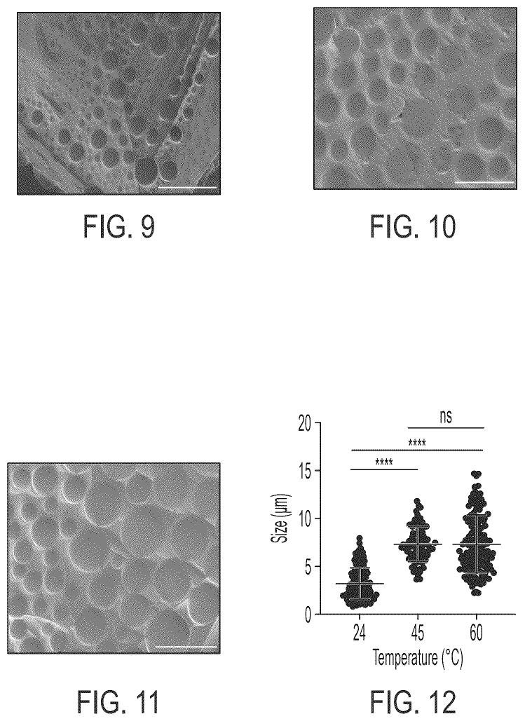

FIGS. 9-11 provide SEM images of phase separated microdomains collected on a SEM microscope (Tescan Lyra 3 GMU, Warrendale, Pennsylvania). Dextran samples (30 L each) at 1 mg/mL polysaccharide concentrations were prepared in phosphate-buffered saline solution (PBS, pH~7.4) and heated at various temperatures 24° C., 45° C. and 60° C. For analysis in SEM, aluminum stub specimen holders were prepared with carbon conductive paint coating and covered with cover slips. Dex-MA solutions were deposited onto the coverslip in dropwise manner and incubated for 12-24 hours to prepare dry films. The dried samples were then sputter-coated with 15 nm gold palladium prior to imaging. The SEM experiments were performed at 3 kV accelerating voltage and the images were captured using a secondary electron detector in the sample chamber. The average size of phase-separated particles were quantified via ImageJ (NIH software, Bethesda, MD). FIG. 9 shows images of Dex-MA (Mw: 86 kDa, f=88%, 1 mg/mL in PBS (pH~7.4)) dried at 24° C. below the transition temperature, FIG. 10 at 45° C. above the transition temperature and FIG. 11 at 60° C. above the transition temperature. FIG. 12 provides a scatter diagram of microdomain size distribution at various temperatures with statistical analysis. Scale bars: 20 μm. (****P<0.0001)

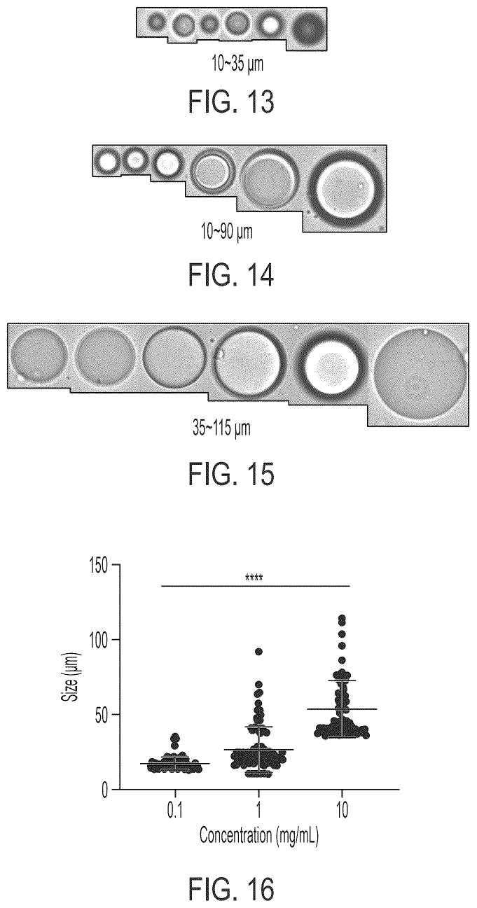

FIGS. 13-16 provide flow imaging microscopy data for various samples. Particle morphology, counts and size were captured via FlowCam 8100 (Yokogawa Fluid Imaging Technologies, Scarborough, Maine), and data analysis was performed using Visual Spreadsheet software. The 88% Dex-MA samples were prepared in PBS at three different concentrations: 0.1 mg/mL (FIGS. 13), 1 mg/mL (FIG. 14), and 10 mg/mL (FIG. 15). The solution temperatures were 24° C., 45° C. and 60° C. for 10, 1 and 0.1 mg/mL concentrations, respectively. A 1 mL aliquot of each sample was inserted into the flow cell at approximately a 150 μL/min flow rate. The instrument was equipped with a 10× objective and grayscale camera to capture the particles in the solution stream. The Visual Spreadsheet software separates the particle images from the background as soon as each frame of the camera's field of view is collected. The frequency of microdomain counts is directly proportional to concentration; for example, it was found that 0.1 mg/mL concentration had around 32,000 counts of domains while 10 mg/mL concentration had approximately 115,000 counts based on the particle size distribution.

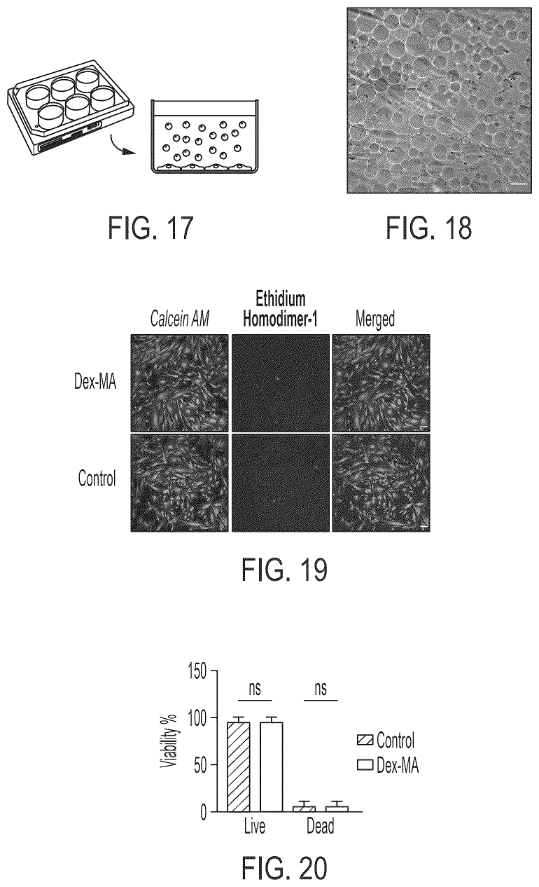

Experiments were completed to determine the compatibility of Dex-MA with human cells. Human dermal fibroblasts (HDFs, passage ~7-9, Lonza, Basel, Switzerland) were cultured in fully supplemented Dulbecco's Modified Eagle's Medium (DMEM) (Lonza, Basel, Switzerland). All cells were cultured in a humidified incubator at 37° C. with 5% CO₂. HDFs were cultured to 80% confluency before seeding in 35 mm MatTek glass bottom dishes (300,000 cells per dish). After culturing for 24 hours, cell media was replaced with 2 mL DMEM media containing 88% Dex-MA at 10 mg/mL concentration for an additional 24 hours before fixation. FIG. 17 provides a schematic demonstration of the setup of in vitro cell culture in the presence of phase separated Dex-MA solution, where floating dots represent phase-separated microdomains in solution and green corresponds to attached HDFs. FIG. 18 provides a phase contrast microscope image of cells and phase separated Dex-MA (Mw: 86 kDa, f=88%) in DMEM media after seeding at 10 mg/mL concentration.

Human dermal fibroblasts (HDFs, passage 4-8) were cultured in DMEM media to 80% confluency on TCPS before seeding in 35 mm MatTek glass bottom dishes (100,000 cells per dish). After culturing for 24 hours, cell media was replaced with 2mL DMEM media containing 10 mg/mL 88% Dex-MA and live/dead cytotoxicity assay was performed after culturing HDFs in Dex-MA containing DMEM media for additional 24 hours. Calcein AM (2 μM) plus Ethidium homodimer-1 (20 μM) were mixed in 10 mL PBS (pH=7.4) to prepare the live/dead staining solution. Cultured cells were incubated with live/dead solution for 10~15 minutes at room temperature prior to imaging. Fluorescent images were acquired using a Nikon A1R HD confocal microscope. Unless otherwise specified, images were processed and presented as maximum intensity projections. FIG. 19 provides images showing results of the Dex-MA samples and the control samples for the Calcein AM, Ethidium Homodimer-1, and a merged image, respectively. FIG. 20 provides a bar graph illustrating cell viability in DMEM media containing Dex-MA compared to the control group. The results indicate that Dex-MA has no negative effects with regard to human cells.

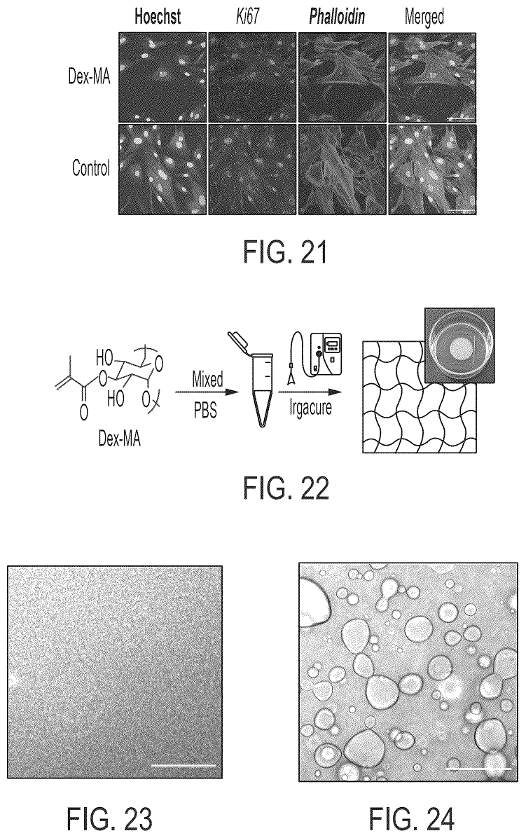

In another experiment, fixed human dermal fibroblasts (HDFs) that were cultured with and without Dex-MA solution were permeabilized with 0.1% triton X-100 in PBS at room temperature for 20 minutes, blocked with 5 wt % goat serum in 0.01% triton X-100 at 4° C. overnight, and incubated with primary antibody Ki67 mouse monoclonal antibody (1:500, Abcam ab15580) in blocking buffer for 24 hours at 4° C. After 24 hours, HDFs were incubated with goat anti-mouse Alexa Fluor 488 (1:1000, Life Technologies); counterstained for nuclei with hoechst (1:500) and for actin cytoskeleton with phalloidin-Alexa Fluor 647 (1:1000, Thermo Fisher Scientific, Waltham, MA) in blocking buffer. Fluorescent images were acquired using a Nikon A1R HD confocal microscope. Unless otherwise specified, images are processed and presented as maximum intensity projections using Image J. Results are shown in FIG. 21 which provides a confocal microscope image of HDF cells cultured in the presence of phase-separated Dex-MA solutions in DMEM media and DMEM media without Dex-MA (control); stained with Hoechst (gray), Ki67 (green) and phalloidin (magenta), respectively. Scale bars: 100 μm.

In another experiment, lyophilized Dex-MA (Mw: 86 kDa, f=88%) was dissolved in PBS (pH=7.4) solutions at 50 mg/mL concentrations. A 10 mg/mL stock solution of the photo-initiator 2-Hydroxy-4′-(2-hydroxyethoxy)-2-methylpropiophenone (Irgacure 2959, Sigma-Aldrich, St. Louis, MO) was prepared in ethanol. 2 μL of photo-initiator solution was added to 100 μL of phase-separated cloudy Dex-MA solution, and the mixture was pipetted gently to ensure proper mixing. The resulting solution was transferred to a MatTek dish and photo-crosslinked using an Omnicure S2000 UV lamp (EXFO) with 365 nm wavelength at 25 mW/cm² intensity for 1 minute under argon to create cross-linked UV-initiated hydrogels. To make non-phase-separated hydrogels, a separate hydrogel precursor solution was prepared and cooled to 4° C. to eliminate the phase separation of Dex-MA solution to generate homogenous, non-phase separated hydrogels. A schematic representation of microstructured hydrogels formation by UV crosslinking is provided in FIG. 22. FIG. 23 is a phase contrast microscope image of photo-crosslinked non phase separated Dex-MA (Mw: 86 kDa, f=88%) hydrogels at 50 mg/mL concentration in PBS (pH~7.4) solution. FIG. 24 provides a phase a contrast microscope image of photo-crosslinked phase separated Dex-MA (Mw: 86 kDa, f=88%) hydrogels at 50 mg/mL concentration in PBS (pH~7.4) solution. Scale bar: 100 μm. The separated domains are clearly visible in FIG. 24 compared to FIG. 23.

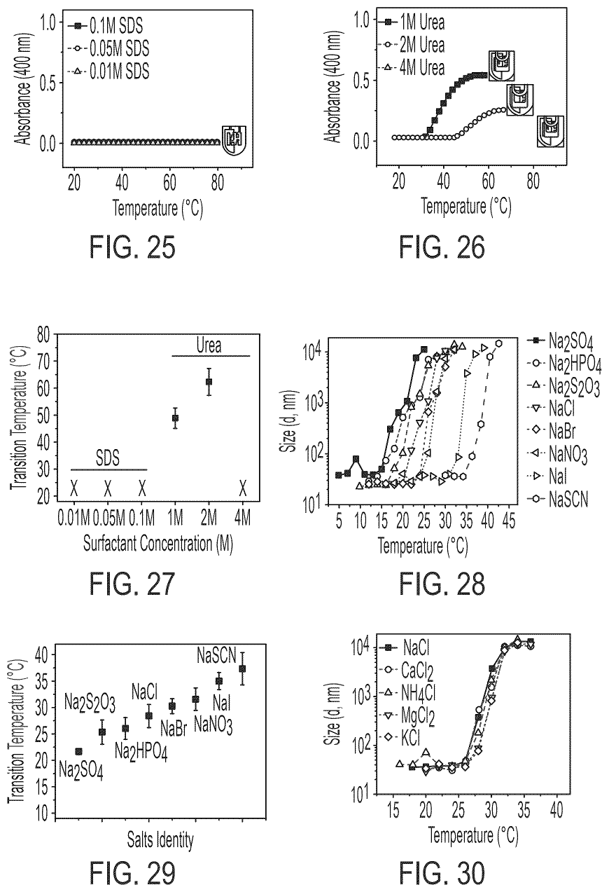

Thermoresponsive behavior is affected, at least in part, by the hydrophobic-hydrophilic balance within macromolecules and stability of hydration between macromolecules and water molecules. The addition of surfactants, urea and salts can potentially change the phase transition by altering that balance. Given that both hydrogen bonding and hydrophobic-hydrophobic interactions are involved in the systems described herein, experiments were carried out adding urea and SDS to modulate the phase transition behavior. Results are illustrated in FIGS. 25-27. FIG. 25 provides results for a turbidity assay of Dex-MA (Mw: 86 kDa, f=88%) in 0.1M, 0.05M and 0.01M SDS at 1 mg/mL sample concentration via UV-vis. FIG. 26 provides a turbidity profile of Dex-MA (Mw: 86 kDa, f=88%) in 1M, 2M and 4M urea at 1 mg/ml sample concentration via UV-vis. FIG. 27 provides a comparison of SDS and urea effects on transition temperature. X refers to no transition temperature observed across the tested temperature range. The results indicate that while a concentration as low as 0.01M SDS can effectively eliminate phase transition, a minimum of 4M urea was required to prevent Dex-MA phase separation. This observation of very high sensitivity to SDS compared to urea means that enhanced hydrophobic-hydrophobic interaction is the dominant driving force to trigger phase separation of these materials.

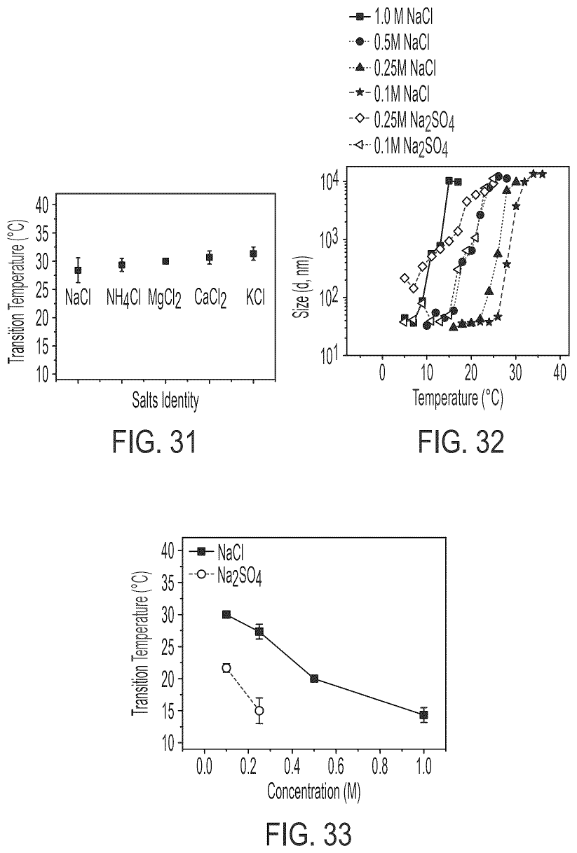

Hofmeister salts were studied to determine their effect on phase separation. Hofmeister effect defines the order of Chaotropic ions (salting-in) and Kosmotropic ions (salting-out) based on the ion's hydration strength in stabilizing or destabilizing polymer solubility during phase separation. By comparing the thermal behavior of Dex-MA aqueous solutions across both series of Hofmeister salts, it was found that all cations characterized had a negligible impact on the phase transition temperatures of Dex-MA solutions while anions induced significant effects on the transition temperatures. See FIGS. 28-33. FIG. 28 graphically illustrates hydrodynamic radius profiles of Dex-MA (Mw: 86 kDa, f=88%) samples as a function of temperature under various anion (0.1M) conditions. FIG. 29 provides a summary of the impact of Hofmeister salts on transition temperature with different anions. FIG. 30 provides hydrodynamic radius profiles of Dex-MA (Mw: 86 kDa, f=88%) samples as a function of temperature under various cation (0.1M) conditions. FIG. 31 provides a summary of the impact of Hofmeister salts with different cations. FIG. 32 provides hydrodynamic radius profiles of Dex-MA (Mw: 86 kDa, f=88%) samples with different concentrations of NaCl (0.1, 0.25, 0.5 and 1.0M) and Na₂SO₄ (0.1 M and 0.25M) salts. FIG. 33 provides a comparison of the impact of NaCl and Na₂SO₄ concentrations on the phase transition temperatures of Dex-MA solutions. Error bars represent the standard deviation of three different trials.

These findings suggest that anions have a profound effect on the LCST behavior of methacrylated polysaccharides compared to cations, which had been previously observed in many systems. It is believed that the discrepancy between Hofmeister anions and cations is in part due to the large size, high polarization capability and different hydration characteristics. The addition of NaCl salts at various ionic strengths significantly lowered the transition temperature, which is in stark contrast to what has been observed in RLPs and is likely caused by ion pairing affecting both electrostatic and hydrophobic interaction.

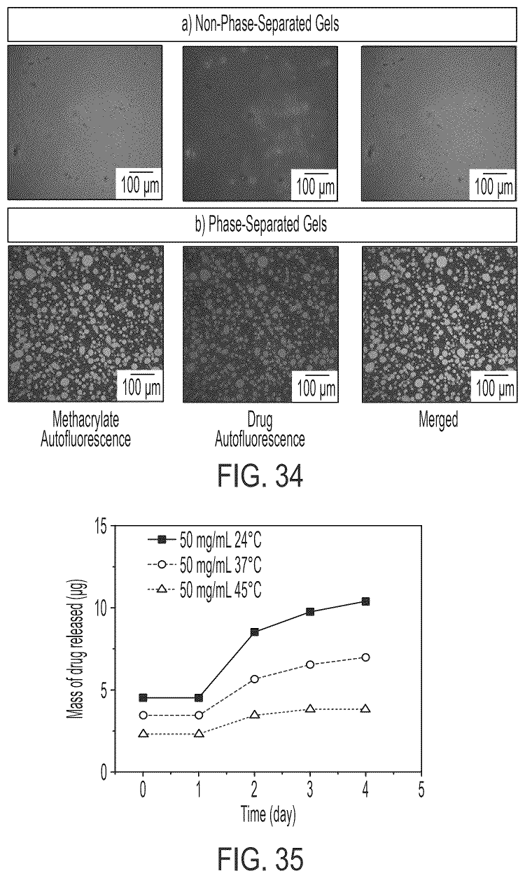

Phase-separated microstructured hydrogels can be utilized as a drug delivery vehicle for encapsulating hydrophobic drugs to avoid burst release. The microstructures can act as reservoirs to retain the drug to ensure sustained release over time. The controlled drug release from the phase-separated microstructures can achieve better therapeutic outcomes compared to traditional UV-crosslinked gels. Hydrogel precursor solutions containing dextran methacrylate (Dex-MA; MW: 86 kDa, f=88%) were made at various compositions and temperatures and the resultant precursor was photo-crosslinked at different UV exposure times. The phase-separated and non-phase-separated hydrogels were tested to determine their effects on drug release behavior by encapsulating doxorubicin as a model drug in the hydrogel precursor. The drug-loaded gels were soaked in PBS buffer and the supernatant was collected over time to quantify the amount of drug released. The micrographs provided in FIG. 34 illustrate the methacrylate autofluorescence as well as the doxorubicin autofluorescence of the drug-loaded gels. The photos show that the drug is retained preferentially at the microdomains of the hydrogel. The drug release profile is affected by the gels compositions, UV exposure time and temperature.

FIG. 35 illustrates the cumulative release of drugs from the phase-separated Dex-MA hydrogels at 50 mg/mL concentrations made at various temperatures. A slower release of drugs was observed in the gels made at 45° C. due to the higher stiffness of the gels. This means that the rate of drug release can be controlled by selecting the temperature at which the hydrogel is made.

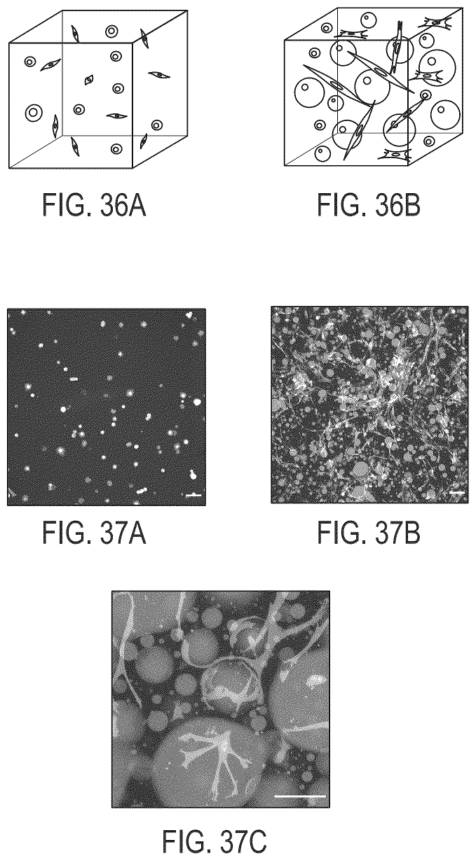

Phase-separated microstructured gels provide an ideal scaffold for enhanced cell spreading. Animations are provided in FIGS. 36a and 36b that illustrate cell proliferation on phase separated (36b) and non-phase separated (36a) materials. Photomicrographs are provided in FIG. 37 that show the encapsulation of human dermal fibroblasts (HDFs) in the non-phase-separated (37a) and phase-separated (37b) hydrogels matrix. Scale bars: 100 μm. The interfacial-driven spreading of the fibroblasts is evident in FIG. 37b when compared to the non-phase separated system of FIG. 37a. FIG. 37c provides a more magnified view showing the enhanced cell spreading and migration in phase-separated hydrogels due to the presence of engineered microstructures.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

1. A reversible phase transition composition comprising:
an aqueous solvent;
between 0.1 mg/mL and 100 mg/mL of a methacrylated polysaccharide in the aqueous solvent, the methacrylated polysaccharide having between 40% and 90% of its available hydroxyl groups per repeating unit methacrylated (methacrylation);
a first state at temperature X wherein the methacrylated polysaccharide is homogeneously dissolved in the aqueous solvent; and
a second state at temperature X+Y wherein the methacrylated polysaccharide is in a solid state and is phase separated from the aqueous solvent, wherein X is between 10° C. and 100° C. and Y is between 1° C., and 20° C.

2. The reversible phase transition composition of claim 1 wherein the reversible phase transition composition is configured to transition from the first state to the second state and then back to the first state.

3. The reversible phase transition composition of claim 1 wherein the methacrylated polysaccharide is a branched glucan.

4. The reversible phase transition composition of claim 1 wherein the methacrylated polysaccharide has an average molecular weight from 40 to 500 kDa.

5. (canceled)

6. (canceled)

7. The reversible phase transition composition of claim 1 wherein the aqueous solvent has a pH of between 6.5 and 8.0.

8. (canceled)

9. The reversible phase transition composition of claim 1 wherein in the first state, a solution absorbance at 400 nm is less 0.3 absorbance units.

10. The reversible phase transition composition of claim 1 wherein in the second state, a solution absorbance at 400 nm is greater than 0.5 absorbance units.

11. The reversible phase transition composition of claim 1 wherein in the first state, an average particle size by dynamic light scattering is less than 500.

12. The reversible phase transition composition of claim 1 wherein in the second state, an average particle size by dynamic light scattering is greater than 500.

13. (canceled)

14. (canceled)

15. The reversible phase transition composition of claim 1 wherein the methacrylated polysaccharide is acylated.

16. The reversible phase transition composition of claim 1 wherein the methacrylated polysaccharide is methacrylated with glycidyl methacrylate.

17. A method of manufacturing a reversible phase transition composition, the method comprising:
increasing the hydrophobicity of a polysaccharide by conjugating a methacrylate moiety to at least one hydroxyl groups per repeating glucose unit available on a polysaccharide backbone of the polysaccharide.

18. The method of claim 17 further comprising:
dissolving the polysaccharide in a solvent;
adding a base catalyst to the solvent;
adding a molar amount of methacrylate to the solvent to produce a mixture; and
precipitating a modified polysaccharide, the modified polysaccharide being more hydrophobic than the polysaccharide.

19. (canceled)

20. (canceled)

21. (canceled)

22. (canceled)

23. (canceled)

24. (canceled)

25. The method of claim 18 wherein the modified polysaccharide is precipitated by adding the solution to an alcohol.

26. (canceled)

27. (canceled)

28. The method of claim 18 further comprising forming a hydrogel from the modified polysaccharide.

29. The method of claim 28 wherein the hydrogel is formed by photo-crosslinking microdomains of the modified polysaccharide above the LCST.

30. The method of claim 28 wherein the hydrogel is formed by photo-crosslinking without microdomains of the modified polysaccharide below the LCST.

31. (canceled)

32. The method of claim 28 further comprising forming at least two different hydrogels from the modified polysaccharide, wherein a first hydrogel of the at least two different hydrogels exhibits a different structural features than a second hydrogel of the at least two hydrogels.

33. The method of claim 18 further comprising changing the LOST by adding a surfactant.

34. (canceled)

35. The method of claim 18 further comprising adding urea to selectively alter the LCST.

36. (canceled)

37. (canceled)

38. (canceled)

39. (canceled)
